(19) United States
(12) Patent Application Publication
(10) Pub. No.: US 2025/0382539 A1
(43) Pub. Date: Dec. 18, 2025

(54) LUBRICANT FOR DRILLING AND COMPLETION FLUIDS

(71) Applicant: Halliburton Energy Services, Inc., Houston, TX (US)

(72) Inventors: Sharad Bhimrao Gotmukle, Pune (IN); Nivika Rajendra Gupta, MH (IN)

(21) Appl. No.: 18/743,761

(22) Filed: Jun. 14, 2024

(51) Int. Cl. C10M 105/14; C09K 8/34; C10M 129/40; C10M 129/46

(52) U.S. Cl. CPC C10M 105/14; C09K 8/34; C10M 129/40; C10M 129/46; C10M 2207/0406; C10M 2207/128

(57) ABSTRACT

Methods and compositions for using lubricants in subterranean formations, and specifically lubricants that comprise certain solvents, surfactants and alcohols or alcohol ethoxylates, and methods for their use, are provided. In one embodiment, the methods include introducing a treatment fluid that includes a base fluid and a lubricant including a glycol component, an alcohol or alcohol ethoxylate component, and at least one nonionic surfactant into at least a portion of a subterranean formation.

### BACKGROUND

The present disclosure relates generally to components of wellbore fluids. More specifically, this disclosure provides a lubricant suitable for use with water-based and oil based drilling fluids of the type used as drilling and drill-IN muds to drill subterranean wells. Still more specifically, this disclosure provides a lubricant, wellbore fluids comprising said lubricant, and methods of treating a wellbore utilizing such lubricants and wellbore fluids.

When drilling or completing wells in earth formations, various fluids are used in the well for a variety of reasons. Common uses for well fluids include: cooling and lubrication of cutting surfaces of drilling apparatus, transportation of pieces of formation or ‘cuttings’ dislodged by the cutting action of the teeth on a drill bit to the surface, controlling formation fluid pressure to prevent blowouts, suspending solids in a well, maintaining well stability, stabilizing and minimizing fluid loss into a formation through which a well is being drilled, fracturing the formation in the vicinity of a well, displacing a fluid within a well with another fluid, testing a well, cleaning a well, transmitting hydraulic horsepower to a drilling apparatus, emplacing a packer, abandoning a well or preparing a well for such abandonment, and otherwise treating a well or a formation.

In most rotary drilling procedures, the drilling fluid takes the form of a ‘mud’, e.g., a liquid having solids suspended therein. The solids function to impart desired rheological properties to the drilling fluid and also to increase the density thereof in order to provide a suitable hydrostatic pressure at the bottom of the well. An important function of the drilling fluid is to reduce the substantial torque on a rotating drill pipe caused by friction between the drill pipe and the wall of the well. If the lubricating properties of the drilling fluids are not sufficient and the drill pipe encounters excessive torque, drilling may be interrupted by costly delays.

After a well has been drilled, the drilling mud is generally replaced with a completion fluid, which is typically a solids-free or acid soluble, nondamaging formulation, selected to minimize reductions in permeability of the producing zone. The density of the completion fluid is generally chosen and controlled to ensure that the hydrostatic head or pressure of the fluid in the wellbore matches the hydrostatic pressure of the column of drilling fluid being displaced.

During the operation of deep wells, a wellbore treatment fluid must exhibit enhanced lubricity. Increased lubricity is often required during wellbore cleanup, coil tubing operations, wireline operations, and the running of production tubulars. For several decades, brines have been utilized for well drilling and completions. High density brines have been found to have particular applicability for use in deep wells. Exemplary high density brines include sodium chloride, potassium chloride, calcium chloride, sodium bromide, calcium bromide, zinc bromide, sodium formate, potassium formate, and cesium formate brines. While high density brines have been found sufficient in providing the lubricity and viscosity of a wellbore treatment fluid under extreme shear, pressure and temperature variances, such brines may prove ineffective if unable to exhibit the constant lubricity required during high shear conditions.

Various components or additives for use as lubricants in water-based drilling fluids as well as completion fluids are known. However, many of the known additives are not compatible with brines, or with drilling fluids or completion fluids containing brine as a major component. For example, ester cleavage of carboxylic acid ester additives often results in the creation of components with a substantial tendency to foam, which introduces undesirable side effects into the fluid systems. Similarly, sulfonates of vegetable oils, which have also been used as lubricants in water-based systems, also generally show undesirably substantial foaming. Furthermore, conventional additives used as lubricating agents in drilling fluids and/or completion fluids may present environmental concerns, and may not be economical in some applications. For example, stricter regulations with regard to biodegradability of drilling fluids and their constituents are reducing the use of otherwise suitable mineral oils.

Accordingly, an ongoing need exists for lubricants compatible with aqueous-based drilling fluids and/or completion fluids, such as those based on brines. When incorporated into wellbore or completion fluids, such lubricants should be effective at lowering torque and drag, and prevent sticking of downhole tubulars. In addition to enhancing lubricity, such lubricants should desirably be compatible with a variety of wellbore fluids.

### BRIEF DESCRIPTION OF THE DRAWINGS

These drawings illustrate certain aspects of some of the embodiments of the present disclosure and should not be used to limit or define the claims.

FIG. 1 is a schematic diagram of a wellbore drilling assembly used in accordance with embodiments of the present disclosure;

FIG. 2 provides pictures after hot rolling (AHR), at 250° F. (121.1° C.) or 300° F. (148.9° C.), of mixtures of an LC of this disclosure with a monovalent brine (10 weight percent (wt %) KCl), a divalent brine (25 wt % CaCl₂), and a water based mud (WBM) (BARADRIL-N™), as described in Example 2.

While embodiments of this disclosure have been depicted, such embodiments do not imply a limitation on the disclosure, and no such limitation should be inferred. The subject matter disclosed is capable of considerable modification, alteration, and equivalents in form and function, as will occur to those skilled in the pertinent art and having the benefit of this disclosure. The depicted and described embodiments of this disclosure are examples only, and not exhaustive of the scope of the disclosure.

### DETAILED DESCRIPTION

Illustrative embodiments of the present disclosure are described in detail herein. In the interest of clarity, not all features of an actual implementation may be described in this specification. It will of course be appreciated that in the development of any such actual embodiment, numerous implementation-specific decisions may be made to achieve the specific implementation goals, which may vary from one implementation to another. Moreover, it will be appreciated that such a development effort might be complex and time-consuming, but would nevertheless be a routine undertaking for those of ordinary skill in the art having the benefit of the present disclosure.

As used herein, “cheese” refers to the formation of insoluble particulates, while “grease” refers to the formation of a separate oleaginous layer (i.e., phase separation) when the lubricant composition (also referred to simply as a “lubricant”) is mixed with a brine or with a WBM comprising a brine.

The present disclosure relates to methods and compositions for using certain lubricants in subterranean formations, and specifically to lubricants that comprise a glycol component, an alcohol and/or alcohol ethoxylate component (also referred to herein simply as an “alcohol or alcohol ethoxylate component” or simply as an “alcohol ethoxylate component” or an “alcohol ethoxylate”), and a nonionic surfactant, and methods for use. More specifically, the present disclosure provides a method for introducing a treatment fluid including a base fluid and a lubricant that includes (e.g., comprises, consists essentially of, or consists of) the glycol component, the alcohol or alcohol ethoxylate component, and the (e.g., at least one) nonionic surfactant into at least a portion of a subterranean formation. In embodiments, the present disclosure provides a composition including a lubricant including a glycol component, an alcohol or alcohol ethoxylate component, and a nonionic surfactant. In embodiments, the present disclosure provides methods for introducing a treatment fluid including a glycol component, an alcohol or alcohol ethoxylate component, and a non-ionic surfactant into at least a portion of a subterranean formation; and using the treatment fluid to drill at least a portion of a well bore penetrating at least a portion of the subterranean formation; wherein a coefficient of friction of the treatment fluid is lower than that of a treatment fluid having the same composition as the treatment fluid but absent the lubricant.

When incorporated into wellbore or completion fluids, the lubricant of this disclosure can be effective at lowering torque and drag, and preventing sticking of downhole tubulars. In addition to enhancing lubricity, the lubricant of this disclosure may be compatible with a variety of wellbore fluids, and/or may be environmentally friendly.

Among the many potential advantages to the methods and compositions of the present disclosure, only some of which are alluded to herein, embodiments of the methods and compositions of the present disclosure may, among other benefits, provide a lubricant that has improved stability as compared to certain other lubricants. In embodiments, the stable lubricant of the present disclosure may provide for improved compatibility with and/or solubility in brine fluids, in particular monovalent and/or divalent brines, as compared to certain other lubricants, which may, for example, produce undesirable foaming and/or agglomeration. In embodiments, the lubricant of the present disclosure may provide for improved stability at high temperatures, with maintenance of lubricity at least up to at least 250° F. (121.1° C.) or 300° F. (148.9° C.). In embodiments, the lubricant of the present disclosure may provide for maintenance of lubricity at higher loads relative to certain other lubricants, for example up to at least 150, 500, 1000, 2000, or 3000 lb, or from about 150 to about 3000, from about 150 to about 2000, or from about 500 to about 3000 lb.

During the operation of, for example, deep wells, a wellbore treatment fluid may exhibit enhanced lubricity. Increased lubricity can be desirable, for example, during wellbore cleanup, coil tubing operations, wireline operations, and the running of production tubulars. In embodiments, the lubricant of the present disclosure may reduce the coefficient of friction (CoF) due to the presence of fine solids and salts in drilling fluids, particularly in water-based drilling fluids. Although the present disclosure may describe drilling, drilling fluids, and drilling muds based on such drilling fluids, it should be understood that modification according to the present disclosure of other fluids used for any subterranean operation (including but not limited to drill-in, completions, workover, and stimulation operations), to include a lubricant of the present disclosure is intended to be within the scope of the present disclosure and claims. Similarly, although the present disclosure may describe water-based drilling fluids and drilling muds based thereon, it should be understood that modification according to the present disclosure of other types of fluids, such as, for example, invert emulsions, is intended to be within the scope of the present disclosure and claims.

Treatment fluids can be used in a variety of above ground and subterranean treatment operations. As used herein, the terms “treat,” “treatment,” “treating,” and grammatical equivalents thereof can refer to any above ground or subterranean operation that uses a fluid in conjunction with achieving a desired function and/or for a desired purpose. Use of these terms does not imply any particular action by the treatment fluid. Illustrative treatment operations can include, for example, surface facilities operations, fracturing operations, gravel packing operations, acidizing operations, scale dissolution and removal, consolidation operations, and the like.

In embodiments, a treatment fluid including a base fluid and a lubricant may be provided. Depending on the type of treatment to be performed, the treatment fluid may include any treatment fluid known in the art. Treatment fluids that may be useful in accordance with the present disclosure include, but are not limited to, wellbore fluids, drilling fluids, cement fluids, lost circulation fluids, stimulation fluids (e.g., a fracturing fluids or an acid stimulation fluids), completion fluids, conformance fluids (e.g., water or gas shutoff fluids), sand control fluids (e.g., formation or proppant consolidating fluids), workover fluids, and/or any combination thereof.

The lubricant (also referred to as a “lubricant composition” or “LC”) of the present disclosure comprises a glycol or a derivative thereof (referred to herein as a “glycol component”), an alcohol or alcohol ethoxylate component, and a nonionic surfactant. In embodiments, the LC of this disclosure comprises from about 5 to about 95, from about 10 to about 90, or from about 20 to about 80 weight percent (wt %) of the glycol component, from about 0.25 to about 50, from about 5 to about 20, or from about 7.5 to about 15 weight percent (wt %) of the alcohol or alcohol ethoxylate component, and/or from about 0.001 to about 10, from about 0.1 to about 5, or from about 1 to about 3 weight percent (wt %) of the nonionic surfactant.

The LC of this disclosure comprises a glycol component. The glycol component can serve as a solvent and/or to reduce foaming, and can further serve as an emulsifying and/or antifreeze agent. The glycol component can help disperse hydrophobic moieties in aqueous phase (e.g., water of a treatment fluid). The glycol component can comprise a glycol, a glycol derivative (e.g., a glycol ether), or a combination thereof. The glycol can comprise a vicinal diol, a geminal diol, a 1,3-diol, a 1,4-diol, a 1,5-diol, a derivative thereof (e.g., a glycol ether), or a combination thereof. In embodiments, the glycol component comprises a glycol derivative, such as a glycol ether.

In embodiments, the glycol component comprises a mutual solvent. A “mutual solvent” is soluble in oil, water and acid-based treatment fluids. Mutual solvents are routinely used in a range of applications, such as removing heavy hydrocarbon deposits, controlling the wettability of contact surfaces before, during or after a treatment, and preventing or breaking emulsions. Ethylene glycol monobutyl ether, also known as 2-butoxyethanol, and generally known as EGMBE is a mutual solvent. EGMBE is an organic compound comprising a butyl ether of ethylene glycol, and having the chemical formula BuOC₂H₄OH (Bu=CH₃CH₂CH₂CH₂).

In embodiments, the glycol component comprises propylene glycol (PG), ethylene glycol, polyethylene glycol (PEG), butyl glycol (ethylene glycol monobutyl ether, EGMBE), or a combination thereof. In embodiments, the lubricant of this disclosure comprises from about 50 wt % to about 99 wt %, from about 70 wt % to about 95 wt %, from about 75 wt % to about 95 wt %, from about 80 wt % to about 95 wt %, from about 85 wt % to about 95 wt %, from about 85 wt % to about 90 wt %, from about 87 wt % to about 95 wt %, or from about 87 wt % to about 90 wt % of the glycol component. In embodiments, the lubricant may include greater than or equal to about 70, 75, 80, 85, 87, or 90 weight percent of the glycol component. In embodiments, the lubricant can include about 80, 81, 82, 83, 84, 85, 86, 87, 88, 89, 90, 91, 92, 93, 94, or 95 wt % of the glycol component (e.g., propylene glycol, EGMBE, etc.). In embodiments, the lubricant can include about 89 wt % of the glycol component (e.g., propylene glycol, EGMBE, etc.).

The lubricant of this disclosure comprises an alcohol or alcohol ethoxylate component. The alcohol or alcohol ethoxylate component can provide lubricating properties. The alcohol or alcohol ethoxylate component comprises an alcohol (e.g., a long chain or fatty alcohol) and/or an ethoxylate thereof (e.g., an alcohol ethoxylate (e.g., a long chain or fatty alcohol ethoxylate)). In embodiments, the alcohol or alcohol ethoxylate component can comprise a fatty alcohol, an ethoxylate thereof, or a combination of one or more thereof. Fatty alcohols (or “long-chain” alcohols) can be high-molecular-weight, (e.g., straight-chain) primary alcohols, and can range from as few as 4-6 carbons to as many as 22-26 carbon atoms. The fatty alcohol can be derived from natural fats and oils. Fatty alcohols can have an even number of carbon atoms and a single alcohol group (—OH) attached to the terminal carbon. The fatty alcohol can be unsaturated or saturated and can be linear or branched. The fatty alcohol can be referred to generically by the number of carbon atoms in the molecule, such as “a C12 alcohol”, that is an alcohol having 12 carbons, for example dodecanol. In embodiments, the alcohol or alcohol ethoxylate component of the LC of this disclosure can comprise a long chain or “fatty” alcohol having from 8 to 18, from 10 to 18, from 12 to 18, from 12 to 22, from 10 to 16, from 12 to 16, or from 12 to 14 carbon atoms. In embodiments, the alcohol or alcohol ethoxylate component can comprise oleyl alcohol, cetyl alcohol, ethoxylates thereof, or a combination thereof.

In embodiments, as noted hereinabove, the alcohol or alcohol ethoxylate component can comprise a fatty alcohol ethoxylate (FAE). The fatty alcohol ethoxylate can comprise an ethoxylate of a C8 to C22, C10 to C18, or C12 to C22 fatty alcohols, such as lauryl alcohol, cetostearyl alcohol, oleyl cetyl alcohol, behenyl alcohol, stearyl behenyl alcohol, stearyl alcohol, etc. The addition of ethylene oxide (EO) to a fatty alcohol provides a surface-active agent having the carbon rich oleo-based fatty alcohol and the hydrophilic polyoxoethylene portion. Fatty alcohols can be derived from natural sources, such as palm kernel oil, coconut oil, rapeseed oil, castor oil, etc. Synthetic fatty alcohols can be produced in large scale from petroleum-based hydrocarbons by the oxo process. Fatty alcohol ethoxylates thus comprise fatty alcohols, which is oleophilic, and the polyoxoethylene portion, which is hydrophilic. The dual characteristics can allow the fatty alcohol ethoxylate to inhabit the interfaces between oil and water and join them by reducing the interfacial energy, thus providing effective mixing resulting in clear solutions/formulations. FAEs can serve as cleaning agents, scouring agents, wetting agents, dispersants and/or emulsifiers. In embodiments, the alcohol ethoxylate comprises a FAE, such as, without limitation, oleyl cetyl alcohol: C16-18 (unsaturated) 2-60 EO moles; oleyl alcohol: C18 (unsaturated) 5-60 EO moles; tri-decyl alcohol: C13 (branched) 3-100 EO moles; decyl alcohol: C10 (linear) 4-10 EO moles; ceto stearyl alcohol: C16-18 2.5-80 EO moles; auryl alcohol: C12-14 2.5-25 EO moles; behnyl alcohol: C18-22 5-40 EO moles; stearyl alcohol: C8 2-15 EO moles; 2-ethyl hexanol: C8 (branched) 2.5-4.5 EO moles; 2-propyl heptanol: C10 (branched) X EO moles; octyl decyl (C8/C10) alcohol 2-10 EO moles; C12-15 alcohol 2.5-20 EO moles; C8-10 alcohol 2.5-20 EO moles; C12-13 alcohol 2.5-20 EO moles; C11 alcohol 2.5-20 EO moles; trimethalol propane 4.5 EO moles; C9-11 alcohol 2.5-20 EO moles, or a combination thereof. In embodiments, the alcohol ethoxylate comprises a cetearyl alcohol ethoxylate.

In embodiments, the alcohol ethoxylate comprises a long chain alcohol ethoxylate having the formula: R(OCH₂CH₂)ₙOH, wherein R is a saturated or unsaturated, linear or branched hydrocarbyl group having from 8 to 18, from 10 to 18, from 12 to 18, from 10 to 16, from 12 to 16, or from 12 to 14 carbon atoms, and wherein n is a number of ethoxylate (EO) groups. The alcohol ethoxylate can include a linear long chain alcohol ethoxylate (e.g., a branched fatty alcohol ethoxylate). The alcohol ethoxylate can include a branched long chain alcohol ethoxylate (e.g., a branched fatty alcohol ethoxylate). The alcohol ethoxylate can be represented by the formula: R—O(CH₂CH₂O)ₙ—H, wherein R comprises one or more fatty alcohol, and n is the number of ethylene oxide groups. In embodiments, n can be from about 1 to about 11, from about 4, to about 9, from about 8 to about 11, or equal to 1, 2, 3, 4, 5, 6, 7, 8, 9, 10, or 11. In embodiments, n=2. By way of representative example, in embodiments, the alcohol ethoxylate comprises oleyl cetyl alcohol ethoxylate (e.g., ethoxylated oleyl-cetyl alcohol). The oleyl cetyl alcohol ethoxylate can be represented by the formula: R—O(CH₂CH₂O)ₙ—H, wherein R comprises oleyl and cetyl alcohol, and n is the number of ethylene oxide groups. In embodiments, n can be from about 1 to about 11, from about 4, to about 9, from about 8 to about 11, or equal to 1, 2, 3, 4, 5, 6, 7, 8, 9, 10, or 11. In embodiments, n=2. The alcohol ethoxylate can comprise oleyl cetyl alcohol ethoxylate 2 moles (OCAE-2) having 2 moles of ethoxylate per mole. In embodiments, the alcohol ethoxylate has the formula: CH₃(CH₂)₇CH═CH(CH₂)₇CH₂OCH₂CH₂OCH₂(CH₂)₁₄CH₃.

In embodiments, the lubricant of this disclosure comprises from about 10 wt % to about 50 wt %, from about 10 wt % to about 45 wt %, from about 10 wt % to about 40 wt %, from about 10 wt % to about 35 wt %, from about 20 wt % to about 50 wt %, from about 20 wt % to about 45 wt %, from about 20 wt % to about 40 wt %, or from about 30 wt % to about 50 wt % of the alcohol or alcohol ethoxylate component. In embodiments, the lubricant may include greater than or equal to about 10, 20, 30, 40, or 50 weight percent of the alcohol or alcohol ethoxylate component. In embodiments, the lubricant can include about 10, 20, 30, 40, or 50 wt % alcohol or alcohol ethoxylate component.

The lubricant of the present disclosure includes a (e.g., at least one) nonionic surfactant. The “surfactant” described herein is in addition to the alcohol ethoxylate, which can itself be a nonionic surfactant, such as FAE nonionic surfactant. The nonionic surfactant can serve as a dispersant/dispersing agent. The nonionic surfactant can be a hydrophilic surfactant that helps disperse the oily phase into a brine phase of a treatment fluid comprising the LC. In embodiments, the lubricant of this disclosure can include at least two surfactants. In embodiments, the lubricant of this disclosure can include a blend of at least two surfactants. In embodiments, the lubricant of this disclosure can include a blend of at least two nonionic surfactants. In embodiments, the lubricant of this disclosure can include at least three surfactants. In embodiments, the lubricant can include a blend of at least three surfactants. In embodiments, the lubricant of this disclosure can include a blend of at least three nonionic surfactants.

In embodiments, a hydrophilic-lipophilic balance (HLB) of the (e.g., at least one) surfactant may be suitable to form a stable phase when combined in the LC. As used herein, the term “stable phase” refers to a phase that shows minimal or no detectable phase separation and/or coagulation, within the limits of the application. The lubricant of the present disclosure may include an oil soluble surfactant with a low HLB (e.g., an HLB value in the range of from about 1 to about 10). In embodiments, the lubricant may include an oil insoluble surfactant with a higher HLB (e.g., an HLB value in the range of from about 10 to about 20). In embodiments, in absence of a surfactant with a low HLB (e.g., an HLB value in the range of from about 1 to about 10), the oil insoluble surfactant may phase out from a bulk or continuous oil phase including the alcohol ethoxylate. In embodiments, the oil soluble surfactant and the oil insoluble surfactant may together form a reverse micellar system and stabilize the bulk phase including the alcohol ethoxylate.

In embodiments, the stable phase is formed when the at least one surfactant (e.g., the non-ionic surfactant), alone or in combination with the alcohol ethoxylate, provides an HLB value in the range of from about 1 to about 20, from about 2 to about 20, from about 4 to about 18, from about 4 to about 17, from about 4 to about 12, from about 4 to about 8, from about 10 to about 18, from about 12 to about 18, from about 13 to about 17, from about 12 to about 17, from about 12 to about 16, from about 13 to about 16, from about 12 to about 15, from about 13 to about 15, or from about 14 to about 15. In embodiments, the alcohol ethoxylate may form a stable phase when the nonionic surfactant provides an HLB of equal to or about 4, 4.5, 5, 5.5, 6, 6.5, 7, 7.5, 8, 8.5, 9, 9.5, 10, 10.5, 11, 11.5, 12, 12.5, 13, 13.5, 14, 14.5, 15, 15.5, 16, 16.5, 17, 17.5, or 18. The nonionic surfactant may be selected for an optimum surface activity to create a stable phase within the LC. In embodiments, the at least one nonionic surfactant may provide an HLB that is within 1, 2, 3, 4, or 5 of the HLB value suitable to form a stable phase within the LC.

The lubricant of the present disclosure can thus include at least one non-ionic surfactant. Suitable non-ionic surfactants can include, but are not limited to, linear alcohol polyethylene oxide ethers, polyethylene glycol (PEG) esters of fatty acids, sorbitan esters, and/or polyethoxylated sorbitan esters, and the like. In embodiments, the lubricant can include from about 0.5 wt % to about 50 wt %, from about 0.5 wt % to about 40 wt %, from about 0.5 wt % to about 30 wt %, or from about 0.5 wt % to about 20 wt %, from about 0.5 wt % to about 10 wt %, from about 0.5 wt % to about 5 wt %, or from about 0.5 wt % to about 3 wt % of at least one non-ionic surfactant. In embodiments, the lubricant of this disclosure includes less than or equal to about 50, 40, 30, 20, 10, 5, 4, 3, 2, 1, 0.9, 0.8, 0.7, 0.6, or 0.5 weight percent of the at least one non-ionic surfactant.

In embodiments, a lubricant of this disclosure can include at least one non-ionic surfactant selected from sorbitan esters, and/or derivatives thereof, including, but not limited to, sorbitan monolaurate, sorbitan monopalmitate, sorbitan monostearate, sorbitan monooleate, sorbitan sesquioleate, sorbitan trioleate, sorbitan isostearate, polyethoxylated sorbitan esters, or a combination thereof. In embodiments, the LC of this disclosure comprises a polsorbate-type nonionic surfactant. In embodiments, the lubricant can include from about 0.5 wt % to about 40 wt % of at least one sorbitan ester, and/or derivatives thereof, from about 0.5 wt % to about 30 wt % of at least one sorbitan ester, and/or derivatives thereof, from about 0.5 wt % to about 20 wt % of at least one sorbitan ester, and/or derivatives thereof, from about 1 wt % to about 25 wt % of at least one sorbitan ester, and/or derivatives thereof, from about 1 wt % to about 15 wt % of at least one sorbitan ester, and/or derivatives thereof, from about 1 wt % to about 30 wt % of at least one sorbitan ester, and/or derivatives thereof, from about 1 wt % to about 35 wt % of at least one sorbitan ester, and/or derivatives thereof, or from about 20 wt % to about 30 wt % of at least one sorbitan ester, and/or derivatives thereof. In embodiments, the lubricant of this disclosure can include about 0.5, 0.8, 1.0, 1.2, 1.4, 1.6, 1.8, 2.0, 2.2, 2.4, 2.6, 2.8, 3.0, 3.2, 3.4, 3.6, 3.8, 4, 5, 6, 7, 8, 9, 10, 12, 14, 16, 18, 20, 22, 24, 26, 28, 30, 32, 34, 36, 38, or 40 weight percent of at least one sorbitan ester, and/or derivatives thereof.

In embodiments, the lubricant of this disclosure can include a single sorbitan ester. In embodiments, the lubricant can include sorbitan monooleate, [(2R)-2-[(2R,3R,4S)-3,4-dihydroxyoxolan-2-yl]-2-hydroxyethyl] (Z)-octadec-9-enoate, otherwise known as Span™ 80 (available from Croda Inc., Plainsboro, NJ). In embodiments, the lubricant can include at least one sorbitan ester having a molecular weight of less than about 1500, about 1250, about 1000, about 950, about 750, or about 500 Daltons (Da).

In embodiments, a lubricant of this disclosure can include at least one non-ionic surfactant selected from sorbitan polyoxyethylene fatty acid esters, including, but not limited to: polyethylene glycol sorbitan monolaurate, polyethylene glycol sorbitan monopalmitate, polyethylene glycol sorbitan monostearate, polyethylene glycol sorbitan tristearate, polyethylene glycol sorbitan monooleate, or a combination thereof. In embodiments, the non-ionic surfactant of this disclosure can include a sorbitan ester that is polyethoxylated sorbitan monolaurate, polyethoxylated sorbitan monooleate, or a combination thereof. In embodiments, the non-ionic surfactant can include at least one polyethoxylated sorbitan ester including from about 4 to about 20 moles of ethylene oxide, from about 10 to about 20 moles of ethylene oxide, or from about 10 to about 15 moles of ethylene oxide. In embodiments, the non-ionic surfactant can include at least one polyethoxylated sorbitan ester including equal to or about 20 moles of ethylene oxide. For example, suitable non-ionic surfactants may include PEG-20 sorbitan monolaurate, PEG-20 sorbitan monopalmitate, PEG-20 sorbitan monostearate, PEG-20 sorbitan tristearate, PEG-20 sorbitan monooleate, and the like.

In embodiments, the lubricant according to the present disclosure can include a total weight percentage of at least one polyethoxylated sorbitan ester in a range of from about 5 to about 40 wt %, from about 5 to about 30 wt %, from about 10 wt % to about 30 wt %, or from about 15 wt % to about 30 wt % polyethoxylated sorbitan ester. In embodiments, the lubricant can include a total weight percentage of at least one polyethoxylated sorbitan ester equal to or about 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, or 35 weight percent. In embodiments, the lubricant can include one polyethoxylated sorbitan ester. In embodiments, the lubricant can include two polyethoxylated sorbitan esters. In embodiments, the lubricant may include three or more polyethoxylated sorbitan esters. In embodiments, the lubricant can include from about 2 wt % to about 30 wt %, from about 5 wt % to about 25 wt %, or from about 2 wt % to about 10 wt % of each of one or more polyethoxylated sorbitan esters.

In embodiments, the lubricant of this disclosure can include at least one non-ionic surfactant that is sorbitan monooleate (e.g., Span™ 80 (Croda Inc., Plainsboro, NJ)), polyethoxylated sorbitan monooleate (e.g., Tween® 80 (Croda Americas L.L.C., Switzerland), polyethoxylated sorbitan monolaurate (e.g., Tween® 20 (Croda Americas L.L.C., Switzerland), or a combination thereof. In embodiments, the lubricant of this disclosure can include from about 0.1 to about 20, from about 0.5 to about 10, from about 0.5 to about 5, or from about 0.5 o about 1 wt % of sorbitan monooleate, polyethoxylated sorbitan monolaurate, polyethoxylated sorbitan monooleate or a combination thereof.

A lubricant of the present disclosure may be stable at high temperatures (e.g., capable of maintaining lubricity at least up to 250° F. (121.1° C.), or at least up to 300° F. (148.9° C.)). The lubricant may exhibit stability at cold and surface temperatures, e.g., exhibiting no or reduced precipitation and/or color change, at least between temperatures of between 40° F. (4.4° C.) and 120° F. (48.9° C.), between 0° F. (−17.8° C.) and 120° F. (48.9° C.), between 0° F. (−17.8° C.) and 140° F. (60.0° C.), or between 0° F. (−17.8° C.) and 160° F. (71.1° C.).

In embodiments, the LC of this disclosure comprises from about 5 to about 95, from about 10 to about 90, or from about 20 to about 80 weight percent (wt %) of the glycol component, wherein the glycol component comprises a glycol (e.g., propylene glycol), a glycol ether (EGMBE), or a combination thereof; from about 0.25 to about 50, from about 5 to about 20, or from about 7.5 to about 15 weight percent (wt %) of the alcohol or alcohol ethoxylate component (e.g., a fatty alcohol and/or fatty alcohol ethoxylate); and from about 0.001 to about 10, from about 0.1 to about 5, or from about 1 to about 3 weight percent (wt %) of the nonionic surfactant (e.g., sorbitan monooleate (e.g., Span™ 80 (Croda Inc., Plainsboro, NJ)), polyethoxylated sorbitan monooleate (e.g., Tween® 80 (Croda Americas L.L.C., Switzerland), and/or polyethoxylated sorbitan monolaurate (e.g., Tween™ 20). In embodiments, the LC of this disclosure comprises from about 5 to about 95, from about 10 to about 90, or from about 20 to about 80 weight percent (wt %) of the glycol component, wherein the glycol component comprises a glycol (e.g., propylene glycol, polyethylene glycol, and/or ethylene glycol), a glycol ether (EGMBE), or a combination thereof; from about 0.25 to about 50, from about 5 to about 20, or from about 7.5 to about 15 weight percent (wt %) of the alcohol or alcohol ethoxylate component, wherein the alcohol or alcohol ethoxylate component comprises a fatty alcohol and/or an ethoxylate thereof, such as OCAE-2; and from about 0.001 to about 10, from about 0.1 to about 5, or from about 1 to about 3 weight percent (wt %) of the nonionic surfactant, wherein the nonionic surfactant includes polyethoxylated sorbitan monolaurate (e.g., Tween™ 20). In embodiments, the LC of this disclosure comprises from about 5 to about 95, from about 10 to about 90, or from about 20 to about 80 weight percent (wt %) of the glycol component (e.g., propylene glycol); from about 0.25 to about 50, from about 5 to about 20, or from about 7.5 to about 15 weight percent (wt %) of the alcohol or alcohol ethoxylate component (e.g., OCAE (e.g., OCAE-2)); and from about 0.001 to about 10, from about 0.1 to about 5, or from about 1 to about 3 wt % of the nonionic surfactant (e.g., polyethoxylated sorbitan monolaurate nonionic surfactant (e.g., Tween™ 20), polyethoxylated sorbitan monooleate (e.g., Tween® 80), or a combination thereof).

In embodiments, a blend comprising 3 wt % of the LC of this disclosure and a divalent brine (e.g., 25 wt % CaCl₂ brine) has a coefficient of friction of less than 0.15, 0.14, 0.13, 0.12, 0.11, or 0.10 at a reference load of 501 g to 2257 g at room temperature. In embodiments, a blend comprising 3 wt % of the LC of this disclosure and a monovalent brine (e.g., 10 wt % KCl brine) has a coefficient of friction of less than 0.15, 0.14, 0.13, 0.12, 0.11, or 0.10 at a reference load of 501 g to 2257 g at room temperature.

The LC can be formed by blending the components thereof (e.g., the glycol component, the alcohol or alcohol ethoxylate component, and the nonionic surfactant), for example at low speed (e.g., about 200 rpm), at ambient (e.g., room) temperature to obtain a homogeneous LC. As described in Example 1 and Example 2 hereinbelow, the LC of this disclosure can be stable (e.g., no cheese/particulate or grease formation/phase separation) after hot rolling, for example for 16 hours at high temperature (e.g., up to at least 250° F. (121.1° C.), or at least up to 300° F. (148.9° C.))/200 psi nitrogen pressure, in divalent brine (e.g., 25 wt % CaCl₂ brine), at high pH (e.g., pH 9 or more), and in monovalent brine (e.g., 10 wt % KCl brine).

In embodiments, the LC of this disclosure does not comprise a vegetable oil.

The lubricant of the present disclosure may be provided in a treatment fluid. The treatment fluid of the present disclosure may include any base fluid known in the art, including an aqueous fluid, a non-aqueous fluid, an aqueous-miscible fluid, or any combination thereof. As used herein, the term “base fluid” refers to the major component of the fluid (as opposed to components dissolved and/or suspended therein), and does not indicate any particular condition or property of that fluid such as its mass, amount, pH, etc. Suitable base fluids into which the lubricant may be incorporated may include aqueous-based fluid systems, such as brines, water-based muds, and invert emulsion fluid systems, such as water-in-oil emulsions and oil-in-water emulsions.

Aqueous base fluids that may be suitable for use in the methods and compositions of the present disclosure may include water from any source. Such aqueous base fluids may include fresh water, salt water (e.g., water containing one or more salts dissolved therein), brine (e.g., saturated salt water), seawater, and/or any combination thereof. The aqueous base fluids may be from a source that does not contain compounds that adversely affect other components of a fluid. In embodiments of the present disclosure, the aqueous base fluids may include one or more ionic species, such as those formed by salts dissolved in water. For example, seawater and/or produced water may include a variety of divalent cationic species dissolved therein.

In embodiments, an aqueous base fluid according to the present disclosure may include water with one or more water-soluble salts dissolved therein. In embodiments, the one or more salts may include inorganic salts, formate salts, or any combination thereof. Inorganic salts may include monovalent salts, which may be further include alkali metal halides (e.g., sodium chloride), ammonium halides, or a combination thereof. Brines including such monovalent salts may be referred to as “monovalent brines.” Inorganic salts may also include divalent salts, such as alkaline earth metal halides (e.g., CaCl₂, CaBr₂, etc.) and zinc halides. Brines including such divalent salts may be referred to as “divalent brines.” Brines including halide-based salts may be referred to as “halide-based brines.”

In embodiments, the aqueous base fluid may include a monovalent brine, a divalent brine, or a combination thereof. Suitable monovalent brines may include, but are not limited to, sodium chloride brines, sodium bromide brines, potassium chloride brines, potassium bromide brines, and the like. Suitable divalent brines may include, but are not limited to, magnesium chloride brines, calcium chloride brines, calcium bromide brines, and the like.

Monovalent salts may be used to prepare treatment fluids, and may have an aqueous phase having a density up to about 12.5 lb/gal (1498 kg/m³). Divalent salts and formate salts may be used to form drilling or wellbore fluids having an aqueous phase having a density up to about 19.2 lb/gal (2300 kg/m³). In embodiments, the one or more inorganic salts may be in a sufficient concentration such that the density of the aqueous phase is in the range of about 9 lb/gal (1078 kg/m³) to about 19.2 lb/gal (2300 kg/m³). In embodiments according to the present disclosure, the one or more inorganic salts may be selected and in a sufficient concentration such that the density of the aqueous phase is greater than about 9.5 lb/gal (1138 kg/m³). In embodiments according to the present disclosure, the one or more inorganic salts are selected and in a sufficient concentration such that the density of the aqueous phase is greater than about 13 lb/gal (1558 kg/m³).

In embodiments, a treatment fluid of the present disclosure may include brine having a density in the range of from about 9 to about 12.5 lb/gal (pounds per gallon or “ppg”) (from about 1078 to about 1498 kg/m³), from about 9.5 to about 12.5 ppg (from about 1138 to about 1498 kg/m³), or from about 9 to about 12 ppg (from about 1078 to about 1438 kg/m³). In embodiments, a treatment fluid of this disclosure can include a brine having a density of greater than or equal to about 9, 9.5, 10, 10.5, 11, or 11.5 ppg (greater than or equal to about 1078, 1138, 1198, 1258, 1318, or 1378 kg/m³).

Examples of a non-aqueous base fluid that may be suitable for use as a carrier fluid include, but are not limited to an oil, a hydrocarbon, an organic liquid, a mineral oil, a synthetic oil, an ester, or any combination thereof. Examples of non-aqueous base fluids suitable for embodiments of the present disclosure include, but are not limited to, natural oil based muds (OBM), synthetic based muds (SBM), natural base oils, synthetic base oils and invert emulsions. In embodiments, the non-aqueous base fluid may include safra oil. In embodiments, the non-aqueous base fluid may include any petroleum oil, natural oil, synthetically derived oil, or combinations thereof. In embodiments, OBMs and SBMs may include some non-oleaginous fluid such as water, making them water-in-oil type emulsions, also known as invert emulsions wherein a non-oleaginous fluid (e.g. water) includes the internal phase and an oleaginous fluid includes the external phase. The non-oleaginous fluid (e.g. water) may arise in the treatment fluid itself or from the wellbore, or it may be intentionally added to affect the properties of the treatment fluid. Any known non-aqueous fluid may be used to form the external oil phase of the invert emulsion fluid. In embodiments, the non-aqueous base fluid does not include a significant amount of water.

Suitable water-in-oil emulsions, may have an oil-to-water ratio from a lower limit of greater than about 50:50, 55:45, 60:40, 65:35, 70:30, 75:25, or 80:20 to an upper limit of less than about 100:0, 95:5, 90:10, 85:15, 80:20, 75:25, 70:30, or 65:35 by volume in the base fluid, where the amount may range from any lower limit to any upper limit and encompass any subset therebetween. It should be noted that for water-in-oil and oil-in-water emulsions, any mixture of the above may be used including the water being and/or including an aqueous-miscible fluid.

Suitable aqueous-miscible fluids may include, but are not limited to, alcohols (e.g., methanol, ethanol, n-propanol, isopropanol, n-butanol, sec-butanol, isobutanol, and t-butanol; glycerins); glycols (e.g., polyglycols, propylene glycol, and ethylene glycol); polyglycol amines; polyols; any derivative thereof; any in combination with salts (e.g., sodium chloride, calcium chloride, calcium bromide, zinc bromide, potassium carbonate, sodium formate, potassium formate, cesium formate, sodium acetate, potassium acetate, calcium acetate, ammonium acetate, ammonium chloride, ammonium bromide, sodium nitrate, potassium nitrate, ammonium nitrate, ammonium sulfate, calcium nitrate, sodium carbonate, and potassium carbonate); any of the above in combination with an aqueous fluid; or a combination thereof.

In embodiments, the density of the base fluid may be adjusted, among other purposes, to provide additional particulate transport and suspension in the compositions of the present disclosure. In embodiments, the pH of the base fluid may be adjusted (e.g., by a buffer or other pH adjusting agent) to a specific level, which may depend on, among other factors, the types of lubricant, and/or other additives included in the fluid. In embodiments, the treatment fluids may include a mixture of one or more fluids and/or gases, including but not limited to emulsions, foams, and the like.

The lubricant used in accordance with the methods and compositions of the present disclosure may be present in a fluid in an amount sufficient to provide a desired lubricity. In embodiments, the lubricant of this disclosure can be present in the treatment fluid in an amount from about 1% to about 20% by weight of the treatment fluid. In embodiments, the lubricant may be present in the treatment fluid in an amount from about 0.1% to about 10% by weight of the fluid. In embodiments, the lubricant can be present in the treatment fluid in an amount from about 0.5% to about 5% by weight of the treatment fluid. In embodiments, the lubricant can be present in the treatment fluid in an amount of about 2, 3, 4, 5, 6, 7, 8, 9, or 10% by weight of the treatment fluid. In embodiments, the lubricant can be present in the treatment fluid in an amount from about 0.5% to about 10%, from about 0.5% to about 5.0%, from about 0.5% to about 1.5%, from about 1.5% to about 2.5%, from about 2.5% to about 3.5%, from about 3.5% to about 4.5%, or from about 4.5% to about 5.5% by weight of the treatment fluid.

A lubricant according to the present disclosure may be effective in treatment fluids containing monovalent brine, divalent brine, and a combination thereof. The lubricant may be stable to high temperatures, maintaining lubricity up to at least 300° F. (148.9° C.), 325° F. (162.8° C.), 350° F. (176.7° C.), or 360° F. (182.2° C.). The lubricant may be stable at cold and surface temperatures, exhibiting no or reduced precipitation and/or color change, at least between temperatures of between 0° F. and 120° F. The lubricant may provide a reduction in the coefficient of friction of a fluid of up to at least 25%, 30%, 35%, 40%, 45%, 50%, 60%, or 70% relative to an untreated fluid, e.g., a treatment fluid absent the lubricant. In embodiments, a reference load of a fluid can be increased at least about 10% relative to an untreated fluid, e.g., a treatment fluid absent the lubricant. The lubricant may provide a foam-suppressing effect, and may exhibit a minimal amount or tendency to foam when added to a treatment fluid, e.g., a monovalent brine, a divalent brine, or a combination thereof. In embodiments, foaming can be reduced by at least 20%, 30%, 40%, or 50% relative to certain other lubricants.

Treatment fluids of the present disclosure that include a lubricant may exhibit compatibility with high volume percentages of oil contamination. In embodiments, a treatment fluid of the present disclosure that includes a lubricant may be compatible with at least up to 10, 15, 20, or 25 volume percent oil contamination. In embodiments, a treatment fluid including a lubricant of this disclosure can be compatible with at least up to 50, 75, or 100 pounds per barrel (ppb) (at least up to 142.5, 213.8, or 285 kg/m³) cuttings contamination.

In embodiments, the lubricant of this disclosure can maintain lubricity at loads of at least up to 150 lb, 200 lb, 300 lb, 400 lb, 500 lb, 600 lb, 700 lb, 800 lb, 900 lb, 1000 lb, 1100 lb, 1200 lb, 1300 lb, 1400 lb, 1500 lb, 1600 lb, 1700 lb, 1800 lb, 1900 lb, 2000 lb, 2100 lb, 2200 lb, 2300 lb, 2400 lb, 2500 lb, 2600 lb, 2700 lb, 2800 lb, 2900 lb, or 3000 lb, or more.

In embodiments, the treatment fluids used in accordance with the methods of the present disclosure optionally may include any number of additional additives. Examples of such additional additives include, but are not limited to, salts, additional surfactants, acids, proppant particulates, diverting agents, fluid loss control additives, gas, nitrogen, carbon dioxide, surface modifying agents, tackifying agents, foamers, corrosion inhibitors, scale inhibitors, catalysts, clay control agents, shale inhibitors, biocides, additional friction reducers, antifoam agents, bridging agents, flocculants, H₂S scavengers, CO₂ scavengers, oxygen scavengers, lost circulation materials, additional lubricants, additional viscosifiers, breakers, weighting agents, relative permeability modifiers, resins, wetting agents, coating enhancement agents, filter cake removal agents, antifreeze agents (e.g., ethylene glycol or polyethylene glycol), and the like.

In embodiments, the treatment fluids used in accordance with the methods of the present disclosure optionally may include a weighting agent. In embodiments, the weighting agent may be added to produce a desired density in the treatment fluid. In embodiments, the weighting agent may include barite. Examples of other weighting agents include, but are not limited to, hematite, magnetite, iron oxides, illmenite, siderite, celestite, dolomite, olivine, calcite, magnesium oxides, halites, calcium carbonate, strontium sulfate, manganese tetraoxide, and the like. In embodiments, the treatment fluid of this disclosure is substantially solids-free (e.g., comprises no weighting agent). For example, in embodiments, a treatment fluid of this disclosure comprising the LC is a drill-in fluid that is substantially solids-free.

In embodiments, the treatment fluids including a lubricant optionally may include one or more additional surfactants. The additional surfactant may, among other purposes, help disperse the lubricant and/or other additives in a treatment fluid. Examples of additional surfactants that may be suitable for use may include, but are not limited to, an alkoxylated alkyl alcohol and salts thereof, an alkoxylated alkyl phenol and salts thereof, an alkyl or aryl sulfonate, a sulfate, a phosphate, a carboxylate, a polyoxyalkyl glycol, a fatty alcohol, a polyoxyethylene glycol sorbitan alkyl ester, a sorbitan alkyl ester, a polysorbate, a glucoside, a quaternary amine compound, an amine oxide surfactant, or a combination thereof.

The treatment fluids of the present disclosure can be prepared using any suitable method and/or equipment (e.g., blenders, mixers, stirrers, etc.) known in the art at any time prior to their use. The treatment fluids can be prepared at a well site or at an offsite location.

In embodiments, this disclosure provides methods for using the treatment fluids to carry out a variety of subterranean treatments or operations, including but not limited to, drilling operations, cementing operations, fracturing operations, gravel packing operations, workover operations, and the like. In embodiments, the treatment fluids of the present disclosure may be drilling fluids used for drilling a wellbore into a subterranean formation. In embodiments, the treatment fluids of the present disclosure are drilling fluids, such as solids and/or clay-free drill-in fluids, utilized for drilling in a hydrocarbon bearing/containing formation (e.g., a “pay” zone). In embodiments, the treatment fluid comprising the lubricant of this disclosure is a drill-in or “reservoir” fluid designed for drilling through the reservoir section of a wellbore. Such a drill-in fluid can comprise a specially designed mud utilized to successfully drill the reservoir zone. A drill-in fluid is a type of drilling fluid designed especially for drilling through the reservoir section of a wellbore. A drill-in fluid can deliver all the properties of a drilling fluid, but can be designed to not damage the formation. A drill-in fluid can resemble a completion fluid and may be a brine containing only selected solids of appropriate particle size ranges and/or polymers. Only additives essential for filtration control and cuttings carrying may be present in a drill-in fluid. A drill-in fluid can be designed to cause little or no loss of the natural permeability of the pay zone, and to provide superior hole cleaning and easy cleanup.

In embodiments, a treatment fluid including a lubricant can be introduced into a subterranean formation. In embodiments, the subterranean formation can have a bottom hole temperature of from about 66° C. (150° F.) to about 204° C. (400° F.). In embodiments, the subterranean formation can have a bottom hole temperature of from about 93° C. (200° F.) to about 204° C. (400° F.). In embodiments, the subterranean formation can have a bottom hole temperature of from about 93° C. (200° F.) to about 177° C. (350° F.). In embodiments, the subterranean formation can have a bottom hole temperature of at least 177° C. (350° F.). In embodiments, the treatment fluid including the lubricant can be used to drill at least a portion of a wellbore in the subterranean formation. In embodiments, the treatment fluid can circulate through the wellbore while drilling into the subterranean formation. In embodiments, the treatment fluid including the lubricant can be introduced into a wellbore that penetrates a subterranean formation.

In embodiments, the methods of the present disclosure can include foaming the treatment fluid by incorporating air, nitrogen, an appropriate foamer, glass spheres, or any combination thereof into the fluid. In embodiments, the treatment fluid can be introduced into the wellbore using one or more pumps. In embodiments, the lubricant, treatment fluids, and/or additional additives can be utilized in treating a portion of a subterranean formation, for example, in acidizing treatments such as matrix acidizing or fracture acidizing. In embodiments, the treatment fluid including the lubricant can be introduced at a pressure sufficient to create or enhance one or more fractures within the subterranean formation (e.g., hydraulic fracturing).

In embodiments of the present disclosure, the treatment fluids of the present disclosure can be introduced into a subterranean formation, a wellbore penetrating a subterranean formation, tubing (e.g., pipeline), and/or a container using any method or equipment known in the art. Introduction of the treatment fluids of the present disclosure can, in such embodiments, include delivery via any of a tube, umbilical, pump, gravity, or a combination thereof. The treatment fluids of the present disclosure can, in various embodiments, be delivered downhole (e.g., into the wellbore) or into top-side flowlines/pipelines or surface treating equipment.

For example, in embodiments, the lubricant, treatment fluids, and/or additional additives of the present disclosure can be introduced into a subterranean formation and/or wellbore using batch treatments, squeeze treatments, continuous treatments, and/or combinations thereof. In embodiments, a batch treatment can be performed in a subterranean formation by stopping production from the well and pumping a certain amount of the lubricant, treatment fluids, and/or additional additives into a wellbore, which can be performed at one or more points in time during the life of a well. In embodiments, a squeeze treatment can be performed by dissolving the lubricant, treatment fluids, and/or additional additives in a suitable solvent at a suitable concentration and squeezing that solvent carrying the lubricant or additional additives downhole into the formation, allowing production out of the formation to bring the lubricant and/or additional additives to the desired location.

In embodiments, the present disclosure provides methods and compositions for using the lubricant, treatment fluids, and/or additional additives to carry out a variety of subterranean treatments, including but not limited to, preflush treatments, afterflush treatments, hydraulic fracturing treatments, acidizing treatments, sand control treatments (e.g., gravel packing), “frac-pack” treatments, wellbore clean-out treatments, drilling operations, and other operations where a treatment fluid may be useful. Such treatment fluids may include, but are not limited to, drilling fluids, preflush fluids, afterflush fluids, fracturing fluids, acidizing fluids, gravel packing fluids, packer fluids, spacer fluids, and the like.

In the methods and compositions of the present disclosure, the lubricant can be added to, or included in, a treatment fluid in any amount that may effectively increase the lubricity of a fluid to be treated by a desired amount at a desired temperature. In embodiments, an initial amount of lubricant can be added to a treatment fluid followed by subsequent, additional amounts. This technique can, for example, be utilized to increase and/or maintain a concentration of lubricant that may be sufficient to maintain a desired lubricity in a fluid to be treated throughout the course of a given operation.

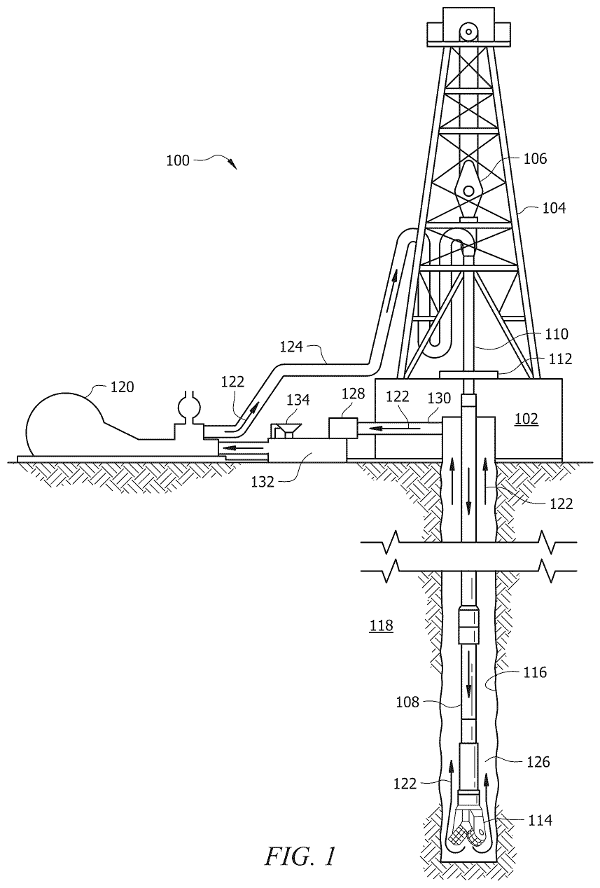

The treatment fluids of the present disclosure can directly or indirectly affect one or more components or pieces of equipment associated with the preparation, delivery, recapture, recycling, reuse, and/or disposal of the disclosed treatment fluids. For example, and with reference to FIG. 1, the herein disclosed treatment fluids may directly or indirectly affect one or more components or pieces of equipment associated with an exemplary wellbore drilling assembly 100, according to one or more embodiments. It should be noted that while FIG. 1 generally depicts a land-based drilling assembly, the principles described herein are equally applicable to subsea drilling operations that employ floating or sea-based platforms and rigs, without departing from the scope of the disclosure.

As illustrated, the drilling assembly 100 may include a drilling platform 102 that supports a derrick 104 having a traveling block 106 for raising and lowering a drill string 108. The drill string 108 may include, but is not limited to, drill pipe and coiled tubing, and the like. A kelly 110 supports the drill string 108 as it is lowered through a rotary table 112. A drill bit 114 is attached to the distal end of the drill string 108 and is driven either by a downhole motor and/or via rotation of the drill string 108 from the well surface. As the bit 114 rotates, it creates a borehole 116 that penetrates various subterranean formations 118.

A pump 120 (e.g., a mud pump) circulates drilling fluid 122 through a feed pipe 124 and to the kelly 110, which conveys the drilling fluid 122 downhole through the interior of the drill string 108 and through one or more orifices in the drill bit 114. The drilling fluid 122 is then circulated back to the surface via an annulus 126 defined between the drill string 108 and the walls of the borehole 116. At the surface, the recirculated or spent drilling fluid 122 exits the annulus 126 and may be conveyed to one or more fluid processing unit(s) 128 via an interconnecting flow line 130. After passing through the fluid processing unit(s) 128, a “cleaned” drilling fluid 122 is deposited into a nearby retention pit 132 (e.g., a mud pit). While illustrated as being arranged at the outlet of the wellbore 116 via the annulus 126, it is to be appreciated that the fluid processing unit(s) 128 may be arranged at any other location in the drilling assembly 100 to facilitate its proper function, without departing from the scope of the scope of the disclosure.

One or more of the disclosed treatment fluids including a lubricant of this disclosure can be added to the drilling fluid 122 via a mixing hopper 134 communicably coupled to or otherwise in fluid communication with the retention pit 132. The mixing hopper 134 may include, but is not limited to, mixers and related mixing equipment. In other embodiments, however, the disclosed treatment fluids may be added to the drilling fluid 122 at any other location in the drilling assembly 100. In at least one embodiment, for example, there could be more than one retention pit 132, such as multiple retention pits 132 in series. Moreover, the retention pit 132 may be representative of one or more fluid storage facilities and/or units where the disclosed treatment fluids may be stored, reconditioned, and/or regulated until added to the drilling fluid 122.

As mentioned above, the disclosed treatment fluids may directly or indirectly affect the components and equipment of the drilling assembly 100. For example, the disclosed treatment fluids may directly or indirectly affect the fluid processing unit(s) 128 which may include, but is not limited to, one or more of a shaker (e.g., shale shaker), a centrifuge, a hydrocyclone, a separator (including magnetic and electrical separators), a desilter, a desander, a separator, a filter (e.g., diatomaceous earth filters), a heat exchanger, and any fluid reclamation equipment. The fluid processing unit(s) 128 may further include one or more sensors, gauges, pumps, compressors, and the like used store, monitor, regulate, and/or recondition the exemplary treatment fluids.

The disclosed treatment fluids may directly or indirectly affect the pump 120, which representatively includes any conduits, pipelines, trucks, tubulars, and/or pipes used to fluidically convey the treatment fluids downhole, any pumps, compressors, or motors (e.g., topside or downhole) used to drive the treatment fluids into motion, any valves or related joints used to regulate the pressure or flow rate of the treatment fluids, and any sensors (e.g., pressure, temperature, flow rate, etc.), gauges, and/or combinations thereof, and the like. The disclosed treatment fluids may also directly or indirectly affect the mixing hopper 134 and the retention pit 132 and their assorted variations.

The disclosed treatment fluids may also directly or indirectly affect the various downhole equipment and tools that may come into contact with the treatment fluids such as, but not limited to, the drill string 108, any floats, drill collars, mud motors, downhole motors and/or pumps associated with the drill string 108, and any MWD/LWD tools and related telemetry equipment, sensors or distributed sensors associated with the drill string 108. The disclosed treatment fluids may also directly or indirectly affect any downhole heat exchangers, valves and corresponding actuation devices, tool seals, packers and other wellbore isolation devices or components, and the like associated with the wellbore 116. The disclosed treatment fluids may also directly or indirectly affect the drill bit 114, which may include, but is not limited to, roller cone bits, PDC bits, natural diamond bits, any hole openers, reamers, coring bits, etc.

While not specifically illustrated herein, the disclosed treatment fluids may also directly or indirectly affect any transport or delivery equipment used to convey the treatment fluids to the drilling assembly 100 such as, for example, any conduits, pipelines, trucks, tubulars, and/or pipes used to fluidically move the treatment fluids from one location to another, any pumps, compressors, or motors used to drive the treatment fluids into motion, any valves or related joints used to regulate the pressure or flow rate of the treatment fluids, and any sensors (e.g., pressure and temperature), gauges, and/or combinations thereof, and the like.

An embodiment of the present disclosure is a method including introducing a treatment fluid that includes a base fluid and a lubricant including a glycol component, at least one nonionic surfactant, and an alcohol or alcohol ethoxylate component into at least a portion of a subterranean formation.

Another embodiment of the present disclosure is a composition including a lubricant that includes a glycol component, an alcohol or alcohol ethoxylate component, and at least one nonionic surfactant.

Another embodiment of the present disclosure is a method including introducing a treatment fluid that includes a glycol component, an alcohol or alcohol ethoxylate component, and a nonionic surfactant into at least a portion of a subterranean formation; and using the treatment fluid to drill at least a portion of a well bore penetrating at least a portion of the subterranean formation; wherein a coefficient of friction of the treatment fluid is lower than a fluid having a same composition as the treatment fluid but not including (e.g., absent) the lubricant.

Another embodiment of the present disclosure is a method including introducing a treatment fluid that includes a base fluid and a lubricant including a glycol component, an alcohol or alcohol ethoxylate component, and at least one nonionic surfactant into at least a portion of a subterranean formation, wherein a coefficient of friction of the treatment fluid is lower than that of a fluid having a same composition as the treatment fluid but absent the lubricant. Optionally in this embodiment or any other embodiment disclosed herein, the base fluid includes at least one component selected from: an aqueous fluid, a non-aqueous fluid, an aqueous-miscible fluid, or a combination thereof. Optionally in this embodiment or any other embodiment disclosed herein, the base fluid includes at least one component selected from: a monovalent brine, a divalent brine, or a combination thereof. Optionally in this embodiment or any other embodiment disclosed herein, the base fluid includes a divalent brine. Optionally in this embodiment or any other embodiment disclosed herein, the base fluid includes a monovalent brine. Optionally in this embodiment or any other embodiment disclosed herein, the glycol component comprises a glycol (e.g., propylene glycol), a glycol derivative (e.g., a glycol ether), or a combination thereof. Optionally in this embodiment or any other embodiment disclosed herein, the alcohol or alcohol ethoxylate component comprises an alcohol (e.g., a long chain or fatty alcohol), an alcohol ethoxylate (e.g., a FAE), or a combination thereof. Optionally in this embodiment or any other embodiment disclosed herein, the at least one nonionic surfactant can be selected from: sorbitan monooleate, polyethoxylated sorbitan monooleate, polyethoxylated sorbitan monolaurate, or a combination thereof.

Another embodiment of the present disclosure is a composition including a lubricant that includes a glycol component, at least one nonionic surfactant, and an alcohol or alcohol ethoxylate component, wherein the composition is a drilling fluid. The drilling fluid can further include a brine (e.g., a monovalent brine, a divalent brine, or a combination thereof). Optionally in this embodiment or any other embodiment disclosed herein, the at least one nonionic surfactant can be selected from: sorbitan monooleate, polyethoxylated sorbitan monooleate, polyethoxylated sorbitan monolaurate, or a combination thereof. Optionally in this embodiment or any other embodiment disclosed herein, the glycol component can be selected from glycols, glycol ethers, or a combination thereof. Optionally in this embodiment or any other embodiment disclosed herein, the alcohol or alcohol ethoxylate component can comprise an alcohol (e.g., a long chain or fatty alcohol) and/or an ethoxylate thereof (e.g., a FAE), as described herein.

Another embodiment of the present disclosure is a method including introducing a treatment fluid that includes a monovalent brine, a divalent brine, or a combination thereof and a lubricant including at a glycol component, an alcohol or alcohol ethoxylate component, and at least one nonionic surfactant, into at least a portion of a subterranean formation; and using the treatment fluid to drill at least a portion of a well bore penetrating at least a portion of the subterranean formation; wherein a coefficient of friction of the treatment fluid is lower than a fluid having a same composition as the treatment fluid but absent the lubricant. The alcohol or alcohol ethoxylate component can comprise a fatty alcohol (FA), an FAE, or a combination thereof. Optionally in this embodiment or any other embodiment disclosed herein, the at least one nonionic surfactant can be selected from: sorbitan monooleate, polyethoxylated sorbitan monooleate, polyethoxylated sorbitan monolaurate, or a combination thereof. Optionally in this embodiment or any other embodiment disclosed herein, the glycol component can comprise a glycol, a glycol ether, or a combination thereof.

A LC of this disclosure can be utilized for high temperature, water-based drilling fluid applications during which conventional lubricants can encounter phase separation, cheesing or greasing when contacting high salinity, high alkalinity, high shearing, and/or high temperature conditions. The LC of this disclosure performs well under such conditions, and does not cheese or grease out in monovalent or divalent brines.

The LC of this disclosure contains a dispersing and anti-foaming agent (e.g., glycol component). In embodiments, the LC of this disclosure does not cheese or grease under high shear, high temperature (e.g., greater than 250° F. (121.1° C.) or 300° F. (148.9° C.)), and/high pH (e.g., greater than or equal to a pH of about 6, 7, 8, 9, or 10) conditions in monovalent brines, divalent brines, and water-based drilling muds (WBMs) (e.g., water-based drilling fluids or drill-in fluids). In addition to providing no cheese or grease, the compositions of this disclosure can, in embodiments, provide improved (e.g., reduced) coefficients of friction.

The alcohol or alcohol ethoxylate component-based lubricant of this disclosure can exhibit stability in monovalent and divalent brines up to at least 250° F. (121.1° C.) or up to at least 300° F. (148.9° C.).

To facilitate a better understanding of the present disclosure, the following examples of certain aspects of embodiments are given. The following examples are not the only examples that could be given according to the present disclosure and are not intended to limit the scope of the disclosure or claims.

### EXAMPLES

The following examples demonstrate compositions of lubricants and laboratory tests conducted to evaluate the ability of the lubricant to provide lubricity according to embodiments of the present disclosure. Percentages set forth in the Examples are weight percentages except as otherwise indicated. Lubricities (measured as coefficients of friction; CoF) were determined utilizing a standard Fann lubricity meter.

### Example 1 Compatibility Testing

This Example 1 describes an example lubricant composition according to this disclosure. The lubricant composition comprised 89 weight percent (wt %) propylene glycol, 10 wt % oleyl cetyl alcohol ethoxylate 2 moles (OCAE2), and 1 wt % TWEEN™ 20. The LC of this disclosure is stable and clear.

The example lubricant composition (LC) of this Example 1 was prepared by combining the components noted above, followed by high shear mixing at ambient temperature for 30 minutes. The specific gravity of the LC was measured to be 1.04 g. The LC had a flash point, as determined by Pensky-Martens Closed Cup (PMCC) flash point tester, above 250° F.

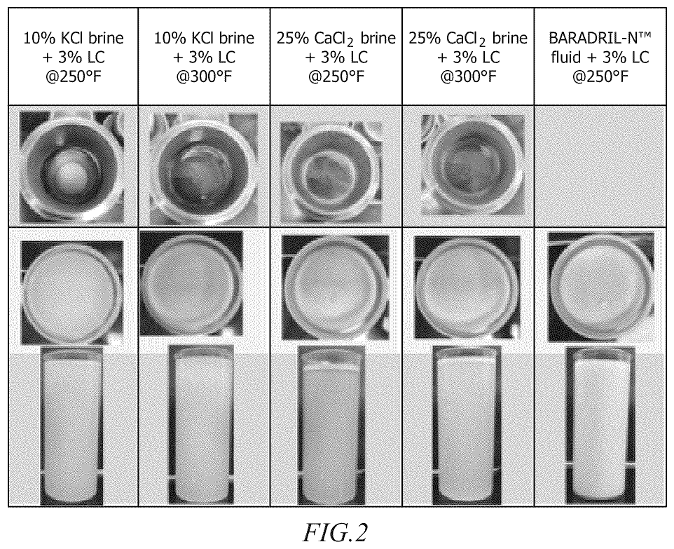

The stability of the LC in solutions of monovalent brines (10 wt % KCl) and divalent brines (25 wt % CaCl₂) was examined. The LC was evaluated by the Cheese or Grease Test. Specifically, 3 wt % of the LC was added to the brine solutions and the WBM, and the resulting mixtures were hot rolled (HR) at 250° F. (121.1° C.) or 300° F. (148.9° C.), as provided in Table 1. Specifically, the test solutions containing 3% LC were hot rolled at 250° F. and 300° F. for 16 h, mixed on a multimixer (MMX) at 11500 rpm for 5 minutes. Each mixture was then transferred to a clean glass container and observed for any layer separation or semi solids precipitate formation or excess foaming. After 30 minutes the appearance of the mixture was observed and reported for the “cheese or grease” tendency of the lubricant. Herein cheese refers to the formation of insoluble particulates, while grease refers to the formation of a separate oleaginous layer (i.e., phase separation) when the lubricant is mixed with a brine or WBM. Photographs were taken after 30 minutes post high shear mixing. FIG. 2 provides images taken 30 minutes post shearing. The top row of FIG. 2 shows images after hot rolling (AHR) AHR and opening the aging cell after the 16 hours. The middle row of FIG. 2 provides top view images AHR and shearing on the MMX for 5 minutes. The bottom row of FIG. 2 provides side view images AHR and shearing on the MMX for 5 minutes. As seen in the images, no cheesing or greasing was observed for the LC in either monovalent or divalent brines after hot rolling. These results demonstrate, inter alia, the stability of the lubricant of the present disclosure in monovalent and divalent brines.

TABLE 1
Data Example 1 and Example 2

| Temperature, | | | Compatib- | | % Torque |
|---|---|---|---|---|---|
| Time | Sample | pH | ility | CoF | Reduction |
| HR = 250° | 10% KCl brine + | 8.02 | Compat- | 0.089 | 73% |
| F., 16 h | 3% LC | | ible | | |
| HR = 300° | 10% KCl brine + | 6.79 | Compat- | 0.134 | 60.5% |
| F., 16 h | 3% LC | | ible | | |
| HR = 250° | 25% CaCl₂ | 8.58 | Compat- | 0.071 | 62% |
| F., 16 h | brine + 3% LC | | ible | | |
| HR = 300° | 25% CaCl₂ | 7.3 | Compat- | 0.143 | 23.5% |
| F., 16 h | brine + 3% LC | | ible | | |
| HR = 250° | BARADRIL-N ™ | 8.85 | Compat- | 0.169 | 28% |
| F., 16 h | WBM + 3% LC | | ible | | |

### Example 2 Lubricity Testing

This Example 2 describes the lubricity performance of the LC of Example 1 in monovalent and divalent brines and in a drill-in fluid (BARADRIL NTM water based mud (WBM) (available from Halliburton Energy Services, Inc.).

Lubricity coefficients of friction (CoF) were determined for various reference loads with 3 weight percent LC in a monovalent brine system (10 wt % KCl), a divalent brine system 25% CaCl₂, and a WBM (BARADRIL-N™ WBM) after hot rolling (HR) at 250° F. (121.1° C.) or 300° F. (148.9° C.), as provided in Table 1 for 16 hours. The lubricity coefficients were determined using a FANN® lubricity meter at 60 rpm and 150 lb load. The results of these measurements are also provided in TABLE 1. The results of this Example 2 demonstrate a 20-75% reduction in torque for the LC of this disclosure in monovalent and divalent brines under these conditions. These results demonstrate, inter alia, the stability of the lubricant composition/formulation of the present disclosure in monovalent and divalent brines and water based muds.

### ADDITIONAL DISCLOSURE

The following are non-limiting, specific embodiments in accordance with the present disclosure.

In a first embodiment, a composition comprises: a lubricant comprising a glycol component, an alcohol or alcohol ethoxylate component, and a nonionic surfactant.

A second embodiment can include the composition of the first embodiment, wherein the composition is a treatment fluid (e.g., a drilling fluid, a completion fluid, drill-in (e.g., reservoir) fluid) that further comprises a (e.g., monovalent and/or divalent) brine.

A third embodiment can include the composition of the second embodiment, wherein the treatment fluid comprises from about 0.1 to about 20, from about 0.25 to about 10, or from about 0.5 to about 3 weight percent of the lubricant.

A fourth embodiment can include the composition of any one of the first to third embodiments, wherein the glycol component comprises a glycol (e.g., a vicinal diol, a geminal diol, a 1,3-diol, a 1,4-diol, a 1,5-diol, a derivative thereof), a glycol ether, or a combination thereof.

A fifth embodiment can include the composition of any one of the first to fourth embodiments, wherein the glycol component comprises propylene glycol, butyl glycol (ethylene glycol monobutyl ether, EGMBE), or a combination thereof.

A sixth embodiment can include the composition of any one of the first to fifth embodiments, wherein the nonionic surfactant comprises: sorbitan monooleate, polyethoxylated sorbitan monooleate, polyethoxylated sorbitan monolaurate, or a combination thereof.

A seventh embodiment can include the composition of any one of the first to sixth embodiments, wherein the alcohol or alcohol ethoxylate component comprises a fatty alcohol ethoxylate, a fatty alcohol, or a combination thereof.

An eighth embodiment can include the composition of any one of the first to seventh embodiments, wherein the alcohol or alcohol ethoxylate component comprises a long chain alcohol ethoxylate having the formula: R(OCH₂CH₂)ₙOH, wherein R is a saturated or unsaturated, linear or branched hydrocarbyl group having from 8 to 18 carbon atoms, and wherein n is a number of ethoxylate groups.

A ninth embodiment can include the composition of any one of the first to eighth embodiments, wherein the alcohol or alcohol ethoxylate component comprises branched long chain alcohol ethoxylate.

A tenth embodiment can include the composition of the ninth embodiment, wherein the alcohol or alcohol ethoxylate component comprises oleyl cetyl alcohol ethoxylate having the formula: R—O(CH₂CH₂O)ₙ—H, wherein R comprises oleyl and cetyl alcohol, and n is a number of ethylene oxide groups.

An eleventh embodiment can include the composition of the tenth embodiment, wherein n is from about 1 to about 11, from about 4, to about 9, from about 8 to about 11, or 1, 2, 3, 4, 5, 6, 7, 8, 9, 10, or 11.

A twelfth embodiment can include the composition of the tenth or eleventh embodiment, wherein n equals 2.

A thirteenth embodiment can include the composition of any one of the tenth to twelfth embodiments, wherein the alcohol or alcohol ethoxylate component has the formula:

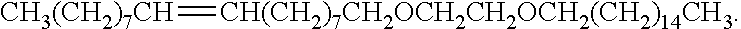

A fourteenth embodiment can include the composition of any one of the first to thirteenth embodiments, wherein the lubricant comprises the glycol component in an amount from about 5 to about 95, from about 10 to about 90, or from about 20 to about 80 weight percent (wt %) of the lubricant.

A fifteenth embodiment can include the composition of any one of the first to fourteenth embodiments, wherein the lubricant comprises the alcohol or alcohol ethoxylate component in an amount from about 0.25 to about 50, from about 5 to about 20, or from about 7.5 to about 15 weight percent (wt %) of the lubricant.

A sixteenth embodiment can include the composition of any one of the first to fifteenth embodiments, wherein the lubricant comprises the nonionic surfactant in an amount from about 0.001 to about 10, from about 0.1 to about 5, or from about 1 to about 3 weight percent (wt %) of the lubricant.

In a seventeenth embodiment, a method comprises: introducing a treatment fluid comprising a base fluid and a lubricant into at least a portion of a subterranean formation, wherein the lubricant comprises a glycol component, an alcohol or alcohol ethoxylate component, and a nonionic surfactant.

An eighteenth embodiment can include the method of the seventeenth embodiment, wherein a coefficient of friction of the treatment fluid is lower than that of a fluid having a same composition as the treatment fluid but absent the lubricant.

A nineteenth embodiment can include the method of the seventeenth or eighteenth embodiment, wherein the base fluid comprises: an aqueous fluid, a non-aqueous fluid, an aqueous-miscible fluid, or a combination thereof.

A twentieth embodiment can include the method of any one of the seventeenth to nineteenth embodiments, wherein the base fluid comprises: a monovalent brine, a divalent brine, or a combination thereof.

A twenty first embodiment can include the method of any one the seventeenth to twentieth embodiments, wherein the base fluid comprises a divalent brine.

A twenty second embodiment can include the method of any one of the seventeenth to twenty first embodiments, wherein the glycol component comprises a glycol (e.g., vicinal diol, a geminal diol, a 1,3-diol, a 1,4-diol, a 1,5-diol, a derivative thereof), a glycol derivative (e.g., a glycol ether), or a combination thereof.

A twenty third embodiment can include the method of any one of the seventeenth to twenty second embodiments, wherein the glycol component comprises propylene glycol, butyl glycol (ethylene glycol monobutyl ether, EGMBE), or a combination thereof.

A twenty fourth embodiment can include the method of any one of the seventeenth to twenty third embodiments, wherein the nonionic surfactant comprises: sorbitan monooleate, polyethoxylated sorbitan monooleate, polyethoxylated sorbitan monolaurate, or a combination thereof.

A twenty fifth embodiment can include the method of any one of the seventeenth to twenty fourth embodiments, wherein the alcohol or alcohol ethoxylate component comprises a fatty alcohol ethoxylate.

A twenty sixth embodiment can include the method of any one of the seventeenth to twenty fifth embodiments, wherein the alcohol or alcohol ethoxylate component comprises a long chain alcohol ethoxylate having the formula: R(OCH₂CH₂)ₙOH, wherein R is a saturated or unsaturated, linear or branched hydrocarbyl group having from 8 to 18 carbon atoms, and wherein n is a number of ethoxylate groups.

A twenty seventh embodiment can include the method of any one of the seventeenth to twenty sixth embodiments, wherein the alcohol or alcohol ethoxylate component comprises branched long chain alcohol ethoxylate, a long chain alcohol, or a combination thereof, wherein long chain comprises greater than or equal to about 8, 9, 10, 11, 12, 13, 14, 15, 16, 17, 18, 19, 20, 21, or 22 carbon atoms.

A twenty eighth embodiment can include the method of the twenty seventh embodiment, wherein the alcohol or alcohol ethoxylate component comprises oleyl cetyl alcohol ethoxylate having the formula: R—O(CH₂CH₂O)ₙ—H, wherein R comprises oleyl and cetyl alcohol, and n is a number of ethylene oxide groups.

A twenty ninth embodiment can include the method of the twenty eighth embodiment, wherein n is from about 1 to about 11, from about 4, to about 9, from about 8 to about 11, or 1, 2, 3, 4, 5, 6, 7, 8, 9, 10, or 11.

A thirtieth embodiment can include the method of the twenty ninth embodiment, wherein n=2.

A thirty first embodiment can include the method of any one of the twenty eighth to thirtieth embodiments, wherein the alcohol or alcohol ethoxylate component has the formula:

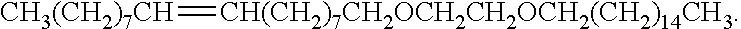

A thirty second embodiment can include the method of any one of the seventeenth to thirty first embodiments, wherein the lubricant comprises the glycol component in an amount from about 5 to about 95, from about 10 to about 90, or from about 20 to about 80 percent by weight (wt %) of the lubricant.

A thirty third embodiment can include the method of any one of the seventeenth to thirty second embodiments, wherein the lubricant comprises the alcohol or alcohol ethoxylate component in an amount from about 0.25 to about 50, from about 5 to about 20, or from about 7.5 to about 15 percent by weight (wt %) of the lubricant.

A thirty fourth embodiment can include the method of any one of the seventeenth to thirty third embodiments, wherein the lubricant comprises the nonionic surfactant in an amount from about 0.001 to about 10, from about 0.1 to about 5, or from about 1 to about 3 percent by weight (wt %) of the lubricant.

A thirty fifth embodiment can include the method of any one of the seventeenth to thirty fourth embodiments, wherein the treatment fluid comprises from about 0.1 to about 20, from about 0.25 to about 10, or from about 0.5 to about 3 weight percent of the lubricant.

In a thirty sixth embodiment, a method comprises: introducing a treatment fluid comprising a base fluid and a lubricant into at least a portion of a subterranean formation, wherein the lubricant comprises a glycol component, an alcohol or alcohol ethoxylate component, and a nonionic surfactant; and using the treatment fluid during drilling (e.g., drill-in) or completions of at least a portion of a well bore penetrating at least a portion of the subterranean formation, wherein a coefficient of friction of the treatment fluid is lower than a fluid having a same composition as the treatment fluid but does not comprise the lubricant.

A thirty seventh embodiment can include the method of the thirty sixth embodiment, wherein the base fluid comprises: an aqueous fluid, a non-aqueous fluid, an aqueous-miscible fluid, or a combination thereof.

A thirty eighth embodiment can include the method of the thirty sixth embodiment, wherein the base fluid comprises a brine (e.g., a monovalant brine, a divalent brine, or a combination thereof).

A thirty ninth embodiment can include the method of any one of the thirty sixth to thirty eighth embodiments, wherein the base fluid comprises: a monovalent brine, a divalent brine, or a combination thereof.

A fortieth embodiment can include the method of any one of the thirty sixth to thirty ninth embodiments, wherein the glycol component comprises a glycol (e.g., a vicinal diol, a geminal diol, a 1,3-diol, a 1,4-diol, a 1,5-diol), a derivative thereof (e.g., a glycol ether), or a combination thereof.

A forty first embodiment can include the method of any one of the thirty sixth to fortieth embodiments, wherein the glycol component comprises propylene glycol, butyl glycol (ethylene glycol monobutyl ether, EGMBE), or a combination thereof.

A forty second embodiment can include the method of any one of the thirty sixth to forty first embodiments, wherein the nonionic surfactant comprises: sorbitan monooleate, polyethoxylated sorbitan monooleate, polyethoxylated sorbitan monolaurate, or a combination thereof.

A forty third embodiment can include the method of any one of the thirty sixth to forty second embodiments, wherein the alcohol or alcohol ethoxylate component comprises a fatty alcohol ethoxylate, a fatty alcohol, or a combination thereof.

A forty fourth embodiment can include the method of any one of the thirty sixth to forty third embodiments, wherein the alcohol or alcohol ethoxylate component comprises a long chain alcohol ethoxylate having the formula: R(OCH₂CH₂)ₙOH, wherein R is a saturated or unsaturated, linear or branched hydrocarbyl group having from 8 to 18 carbon atoms, and wherein n is a number of ethoxylate groups.

A forty fifth embodiment can include the method of any one of the thirty sixth to forty fourth embodiments, wherein the alcohol or alcohol ethoxylate component comprises branched long chain alcohol ethoxylate, a long chain alcohol, or a combination thereof, wherein long chain comprises greater than or equal to about 8, 9, 10, 11, 12, 13, 14, 15, 16, 17, 18, 19, 20, 21, or 22 carbon atoms (e.g., 12-18) carbon atoms.

A forty sixth embodiment can include the method of the forty fifth embodiment, wherein the alcohol or alcohol ethoxylate component comprises oleyl cetyl alcohol ethoxylate having the formula: R—O(CH₂CH₂O)ₙ—H, wherein R comprises oleyl and cetyl alcohol, and n is a number of ethylene oxide groups.

A forty seventh embodiment can include the method of the forty sixth embodiment, wherein n is from about 1 to about 11, from about 4, to about 9, from about 8 to about 11, or 1, 2, 3, 4, 5, 6, 7, 8, 9, 10, or 11.

A forty eighth embodiment can include the method of the forty sixth or forty seventh embodiment, wherein n equals 2.

A forty ninth embodiment can include the method of any one of the thirty sixth to forty eighth embodiments, wherein the alcohol or alcohol ethoxylate component comprises an alcohol ethoxylate having the formula: CH₃(CH₂)₇CH═CH(CH₂)₇CH₂OCH₂CH₂OCH₂(CH₂)₁₄CH₃.

A fiftieth embodiment can include the method of any one of the thirty sixth to forty ninth embodiments, wherein the lubricant comprises the glycol component in an amount from about 5 to about 95, from about 10 to about 90, or from about 20 to about 80 percent by weight (wt %) of the lubricant.

A fifty first embodiment can include the method of any one of the thirty sixth to fiftieth embodiments, wherein the lubricant comprises the alcohol or alcohol ethoxylate component in an amount from about 0.25 to about 50, from about 5 to about 20, or from about 7.5 to about 15 percent by weight (wt %) of the lubricant.

A fifty second embodiment can include the method of any one of the thirty sixth to fifty first embodiments, wherein the lubricant comprises the nonionic surfactant in an amount from about 0.1 to about 5, or from about 1 to about 3 percent by weight (wt %) of the lubricant.

A fifty third embodiment can include the method of any one of the thirty sixth to fifty second embodiments, wherein the treatment fluid comprises from about 0.1 to about 20, from about 0.25 to about 10, or from about 0.5 to about 3 weight percent of the lubricant.

The present disclosure is well adapted to attain the ends and advantages mentioned as well as those that are inherent therein. The particular embodiments disclosed above are illustrative only, as the present disclosure may be modified and practiced in different but equivalent manners apparent to those skilled in the art having the benefit of the teachings herein. While numerous changes may be made by those skilled in the art, such changes are encompassed within the spirit of the subject matter defined by the appended claims. Furthermore, no limitations are intended to the details of construction or design herein shown, other than as described in the claims below. It is therefore evident that the particular illustrative embodiments disclosed above may be altered or modified and all such variations are considered within the scope and spirit of the present disclosure. In particular, every range of values (e.g., “from about a to about b,” or, equivalently, “from approximately a to b,” or, equivalently, “from approximately a-b”) disclosed herein is to be understood as referring to the power set (the set of all subsets) of the respective range of values. The terms in the claims have their plain, ordinary meaning unless otherwise explicitly and clearly defined by the patentee. When a feature is described as ‘optional,” both embodiments with this feature and embodiments without this feature are disclosed. Similarly, the present disclosure contemplates embodiments where this feature is required and embodiments where this feature is specifically excluded

What is claimed is:

1. A composition comprising:
a lubricant comprising a glycol component, an alcohol or alcohol ethoxylate component, and a nonionic surfactant.

2. The composition of claim 1, wherein the composition is a treatment fluid that further comprises a brine.

3. The composition of claim 2, wherein the treatment fluid comprises from about 0.1 to about 20 weight percent of the lubricant.

4. The composition of claim 1, wherein the glycol component comprises a glycol, a glycol ether, or a combination thereof.

5. The composition of claim 1, wherein the glycol component comprises propylene glycol, butyl glycol (ethylene glycol monobutyl ether, EGMBE), or a combination thereof.

6. The composition of claim 1, wherein the nonionic surfactant comprises: sorbitan monooleate, polyethoxylated sorbitan monooleate, polyethoxylated sorbitan monolaurate, or a combination thereof.

7. The composition of claim 1, wherein the alcohol or alcohol ethoxylate component comprises a fatty alcohol ethoxylate, a fatty alcohol, or a combination thereof.

8. The composition of claim 1, wherein the alcohol or alcohol ethoxylate component comprises a long chain alcohol ethoxylate having the formula: R(OCH₂CH₂)ₙOH, wherein R is a saturated or unsaturated, linear or branched hydrocarbyl group having from 8 to 18 carbon atoms, and wherein n is a number of ethoxylate groups.

9. The composition of claim 1, wherein the lubricant comprises the glycol component in an amount from about 5 to about 95 weight percent (wt %) of the lubricant.

10. The composition of claim 1, wherein the lubricant comprises the alcohol or alcohol ethoxylate component in an amount from about 0.25 to about 50 weight percent (wt %) of the lubricant.

11. The composition of claim 1, wherein the lubricant comprises the nonionic surfactant in an amount from about 0.001 to about 10 weight percent (wt %) of the lubricant.

12. A method comprising:
introducing a treatment fluid comprising a base fluid and a lubricant into at least a portion of a subterranean formation, wherein the lubricant comprises a glycol component, an alcohol or alcohol ethoxylate component, and a nonionic surfactant.

13. The method of claim 12, wherein a coefficient of friction of the treatment fluid is lower than that of a fluid having a same composition as the treatment fluid but absent the lubricant.

14. The method of claim 12, wherein the glycol component comprises a glycol, a glycol derivative, or a combination thereof.

15. The method of claim 12, wherein the nonionic surfactant comprises: sorbitan monooleate, polyethoxylated sorbitan monooleate, polyethoxylated sorbitan monolaurate, or a combination thereof.

16. The method of claim 12, wherein the alcohol or alcohol ethoxylate component comprises a fatty alcohol ethoxylate.

17. The method of claim 12, wherein the alcohol or alcohol ethoxylate component comprises a long chain alcohol ethoxylate having the formula: R(OCH₂CH₂)ₙOH, wherein R is a saturated or unsaturated, linear or branched hydrocarbyl group having from 8 to 18 carbon atoms, and wherein n is a number of ethoxylate groups.

18. The method of claim 12, wherein the alcohol or alcohol ethoxylate component has the formula: CH₃(CH₂)₇CH═CH(CH₂)₇CH₂OCH₂CH₂OCH₂(CH₂)₁₄CH₃.

19. The method of claim 12, wherein the lubricant comprises the glycol component in an amount from about 5 to about 95 percent by weight (wt %) of the lubricant, wherein the lubricant comprises the alcohol or alcohol ethoxylate component in an amount from about 0.25 to about 50 wt % of the lubricant, wherein the lubricant comprises the nonionic surfactant in an amount from about 0.001 to about 10 wt % of the lubricant, and/or wherein the treatment fluid comprises from about 0.1 to about 20 wt % of the lubricant.

20. A method comprising:
introducing a treatment fluid comprising a base fluid and a lubricant into at least a portion of a subterranean formation, wherein the lubricant comprises a glycol component, an alcohol or alcohol ethoxylate component, and a nonionic surfactant; and
using the treatment fluid during drilling or completions of at least a portion of a well bore penetrating at least a portion of the subterranean formation,
wherein a coefficient of friction of the treatment fluid is lower than a fluid having a same composition as the treatment fluid but does not comprise the lubricant.
